(19) United States
(12) Patent Application Publication
(10) Pub. No.: US 2014/0129396 A1
(43) Pub. Date: May 8, 2014

(54) SYSTEMS AND METHODS FOR REDUCING FRAUDULENT ACTIVITY IN TRANSACTION DISPUTE RESOLUTION

(71) Applicant: EBAY INC., San Jose, CA (US)

(72) Inventor: Bjorn Markus Jakobsson, Portola Valley, CA (US)

(21) Appl. No.: 13/910,926

(22) Filed: Jun. 5, 2013

Related U.S. Application Data
(60) Provisional application No. 61/723,276, filed on Nov. 6, 2012.

(51) Int. Cl. G06Q 50/18; G06Q 30/00

(52) U.S. Cl. CPC G06Q 50/182; G06Q 30/01
USPC 705/30

(57) ABSTRACT

A method and device for resolving a transaction dispute are provided. The method and device provide information related to a disputed transaction to a user and then provide the user with the opportunity to cancel the transaction dispute. The provided information may be information that is relevant to the user and the transaction and associates the user to the transaction. As a result of being presented with information that associates the user with the transaction, the user may be less likely to fraudulently dispute the transaction.

### CROSS REFERENCE TO RELATED APPLICATIONS

Pursuant to 35 U.S.C. §119(e), this application claims priority to the filing date of U.S. Provisional Patent Application No. 61/723,276, filed on Nov. 6, 2012, the disclosure of which is hereby incorporated by reference in its entirety.

### BACKGROUND

1. Technical Field

Embodiments disclosed herein are related to systems and methods for reducing fraudulent activity in transaction dispute resolution. In particular, systems and methods disclosed herein may present a user with relevant information regarding a transaction during a dispute resolution process regarding that transaction that may dissuade the user from fraudulently disputing the transaction while still allowing a legitimate dispute to be reported and resolved.

2. Related Art

Online retailers and online payment service providers suffer losses from fraudulent buyer behavior. Buyers may purchase an item, receive the item, and then dispute the transaction, possibly alleging that they did not receive the item, or they received the wrong item. Since the online entities have limited resources for actually verifying whether the dispute is legitimate, they often believe the dispute and refund the transaction price, or resend the item. This type of fraud is known as “liar-buyer” fraud because the buyer lies during the dispute resolution process to obtain a financial gain to the detriment of the online entity. Psychological studies have shown that people are less likely to proceed with a lie if you confront the would-be liar with information before they have committed to the lie and if you provide them with an easy out at the point where the user makes a decision as to whether to commit to the lie or not.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIGS. 3A-3C are illustrations of a user interface for dispute resolution, consistent with some embodiments.

FIG. 4 is a flowchart illustrating a method for resolving transaction disputes, consistent with some embodiments.

FIG. 5 is a flowchart illustrating a method for deterring fraudulent behavior when disputing transactions, consistent with some embodiments.

FIG. 6 is a flowchart illustrating a method for deterring fraudulent behavior related to a transaction, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

Consistent with some embodiments, there is provided a device for resolving a transaction dispute. The device includes a memory storing transaction information, one or more processors coupled to the memory, the one or more processors configured to retrieve the transaction information based on a received transaction identifier from a user, and a network interface component coupled to the memory and the one or more processors, the network interface component configured to transmit the retrieved transaction information and instructions providing the user with an opportunity to cancel the transaction dispute.

Consistent with some embodiments, there is provided a method for resolving a transaction dispute. The method includes receiving a request to resolve a disputed transaction, retrieving information related to the transaction, transmitting the retrieved information to a user device for presenting the retrieved information to a user before the user disputes the transaction, and providing a user with an opportunity to cancel the disputed transaction.

Consistent with some embodiments, there is also provided a method for deterring fraudulent behavior when disputing a transaction. The method includes steps of receiving an identifier associated with the transaction, sending the received identifier to a server associated with the transaction, receiving information related to the transaction, displaying the information related to the transaction to a user of the client device, and displaying at least one option to the user to cancel the transaction dispute.

Consistent with some embodiments, there is further provided a method for deterring fraudulent behavior related to a transaction. The method includes steps of capturing information related to the transaction, the captured information including details of the transaction, presenting the captured information to the user when the user attempts to engage in fraudulent behavior related to the transaction, and providing the user with a user interface option for canceling the attempt to engage in fraudulent behavior related to the transaction.

These and other embodiments will be described in further detail below with respect to the following figures.

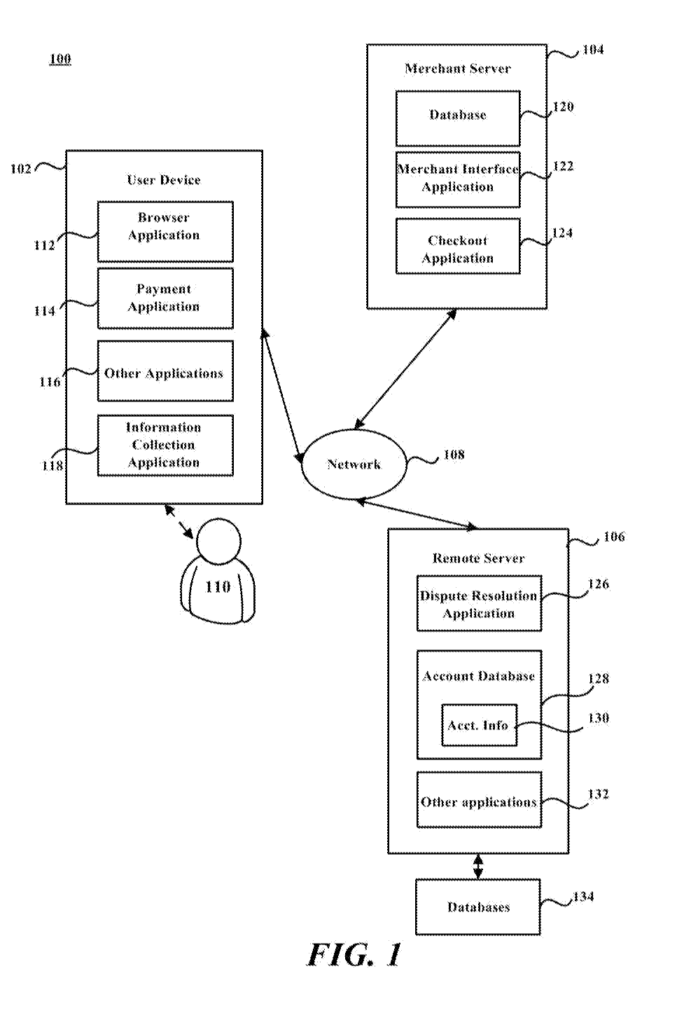

FIG. 1 is a block diagram of a networked system 100, consistent with some embodiments. System 100 includes a user device 102, a merchant server 104, and a remote server 106 in communication over a network 108. User 110 may be communicating with merchant server 104 and/or remote server 106 over network 108 using user device 102. Remote server 106 may be a payment service provider server that may be maintained by a payment provider, such as PayPal, Inc. of San Jose, Calif. Remote server 106 may be maintained by other service providers in different embodiments. Remote server 106 may also be maintained by an entity with which sensitive credentials and information may be exchanged with user device 102 and/or merchant server 104. Remote server 106 may be more generally a web site, an online content manager, a service provider, such as a bank, or other entity who provides content to a user requiring user authentication or login.

Network 108 may be implemented as a single network or a combination of multiple networks. For example, in various embodiments, network 108 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

User device 102 may be a mobile device such as a smartphone, a tablet computer, a laptop or netbook, and the like. User device 102 may also be a personal computer, a set-top box (STB) such as provided by cable or satellite content providers, a video game system console, or a smart or internet-enabled television. User device 102 may also be a head-mounted display (HMD) or other wearable computing device. In some embodiments, user device 102 may be implemented in an automobile, for example in an entertainment center or console of an automobile, or is included or implemented in a healthcare device. User device 102 may be implemented using any appropriate combination of hardware and/or software configured for wired and/or wireless communication over network 108.

Consistent with some embodiments, user device 102 may include any appropriate combination of hardware and/or software having one or more processors and capable of reading instructions stored on a non-transitory machine-readable medium for execution by the one or more processors. Consistent with some embodiments, user device 102 includes a machine-readable medium, such as a memory (not shown) that includes instructions for execution by one or more processors (not shown) for causing user device 102 to perform specific tasks. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which one or more processors or computer is adapted to read. Instructions stored on the machine-readable media may include instructions for authenticating user device 102 to remote server 106 to access services provided by remote server 106 and/or conducting financial transactions with remote server 106 for purchasing items offered by merchant server 104. Such instructions may include instructions for displaying content by particular applications or “apps” stored in a memory of user device 102 and executed by one or more processors executing in user device 102. Example applications include a browser application 112 that displays content, such as a web page or a user interface using a browser, a payment application 114 that is used to make payments in conjunction with remote server 106 for items purchased from, for example, merchant server 104, and other applications 116. Browser application 112 may be implemented as a web browser to view information available over network 108. Browser application 112 may include instructions executable by one or more processors for interfacing and communicating with the remote server 106, a merchant interface provided by merchant server 104, or other servers managed by content providers or merchants via network 108. For example, user 110 may be able to access websites to find and purchase items from a merchant through a payment service provider, such as PayPal, as well as access user account information or web content.

Other applications 116 may be desired in one or more embodiments to provide additional features available to user 110, including accessing a user account with remote server 106. For example, other applications 116 may include interfaces and/or communication protocols that allow the user to receive and transmit information through network 108 and to remote server 106 and other online sites. Other applications 116 may also include security applications for implementing client-side security features, programmatic client applications for interfacing with appropriate application programming interfaces (APIs) over network 108 or various other types of generally known programs and/or applications. Other applications 116 may include mobile apps downloaded and resident on user device 102 that enable user 110 to access content through the apps.

Consistent with some embodiments, user device 102 may also include an information collection application 118. Collection application 118 may collect information about user 110 and/or user device 102. Such information may be collected by sensors in or coupled to user device 102, and may also include information that is captured in a memory of user device 102. The information may be related to a transaction conducted with remote server 106 for, in some embodiments, the purchase of goods and/or services from merchant server 104. The collected information may include time stamps, internet protocol (IP) addresses of user device, a location of user device 102, a picture of user 110, an identification number of user device 102, biometric information about user 110, interaction information about user 110, such as typing patterns, styles, or speeds, or swipe characteristics and the like.

Merchant server 104 may be maintained, for example, by a merchant or seller offering various goods and/or services in exchange for payment to be received over network 108. Consistent with some embodiments, merchant server 104 may be maintained by anyone or any entity that exchanges goods and/or services for money or otherwise receives money, which includes charities as well as retailers and restaurants. Merchant server 104 includes a database 120 identifying available goods and/or services (e.g., collectively referred to as items) which may be made available for viewing and purchase by user 110. Accordingly, merchant server 104 also includes a merchant interface application 122 which may be configured to serve information over network 108 to browser application 110 of user device 102. In certain embodiments, user 110 may interact with merchant interface application 122 through browser application 112 over network 108 in order to view various products, food items, or services identified in database 120. Merchant server 104 also includes a checkout application 124 which may be configured to facilitate the purchase by user 110 of goods or services identified by merchant interface application 122. Checkout application 124 may be configured to accept payment information from or on behalf of user 110 through remote server 106 over network 108. For example, checkout application 124 may receive and process a payment confirmation from remote server 106, as well as transmit transaction information to remote server 106 and receive information from remote server. Checkout application 124 may also be configured to accept one or more different funding sources for payment.

Remote server 106, according to some embodiments, may be maintained by an online payment provider, such as PayPal, Inc. of San Jose, Calif., which may provide processing for online financial and information transactions on behalf of user 110. Remote server 106 may include at least dispute resolution application 126, which may be adapted to interact with user device 102 and user 110 to resolve disputes regarding transactions that user 110 conducted with remote server 106. Such transactions may be payments for items purchased from merchant server 104 that are facilitated by remote server 106. Remote server 106 also may maintain a plurality of user accounts in account database 128, each of which may include account information 130 associated with individual users. For example, account information 130 may include private financial information of users of remote server 106 such as account numbers, credentials, passwords, device identifiers, user names, phone numbers, credit card information, bank information, or other financial information which may be used to facilitate online transactions by user 110. Account information 130 may also include information that was captured by information collection application 118 and transmitted to remote server 106 over network 108. The captured information may be associated with a particular transaction and may be used to verify a transaction and/or used in resolving a dispute regarding a transaction using dispute resolution application. Remote server 106 may also include other applications 132. Such other applications 132 may include a payment processing application used to process payments made by user 110 for purchasing items offered by merchant server 104. Such a payment processing application may be configured to interact with merchant server 104 on behalf of user 110 during a transaction with checkout application 124 to track and manage purchases made by users and which funding sources are used. Other applications 132 may also include a transaction processing application, which may be part of a payment application or separate, may be configured to receive information from a user device 102 and/or merchant server 104 for processing and storage in one or more databases 134. The transaction processing application may include one or more applications to process information from 130 and/or the merchant server 104 for processing a payment from user 110 through a user device 102 while on a website or app as described herein. As such, the transaction processing application of other applications 132 may store details of an order and associate the details with a purchase identifier for individual users. A payment application may be further configured to determine the existence of and to manage accounts in account database 128 for user 110, as well as create new accounts if necessary, such as the setup, management, and use of purchase identifiers.

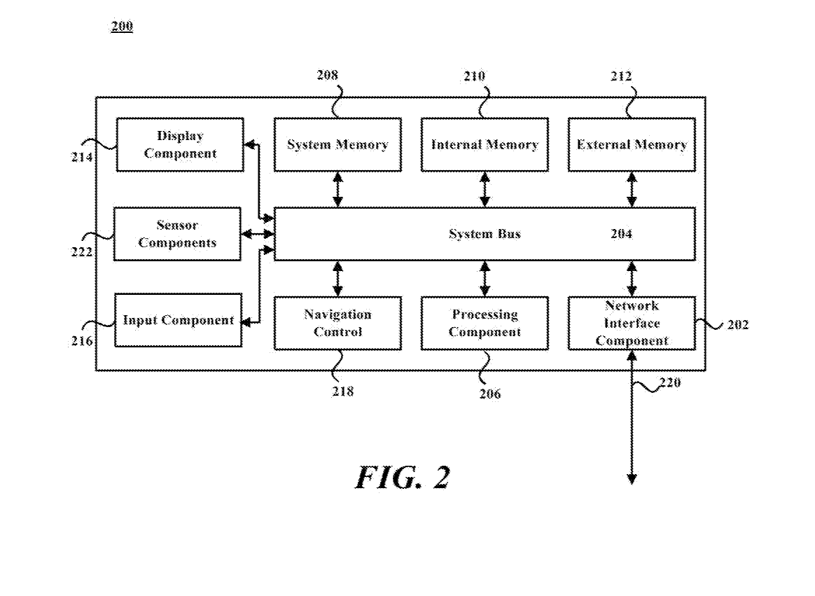

FIG. 2 is a diagram illustrating computing system 200, which may correspond to any of user device 102, merchant server 104, or remote server 106, consistent with some embodiments. Computing system 200 may be a mobile device such as a smartphone, a tablet computer, a laptop or netbook, and the like. Computing system 200 may also be a personal computer, a set-top box (STB) such as provided by cable or satellite content providers, a video game system console, or a smart or internet-enabled television. Computing system 200 may also be a head-mounted display (HMD) or other wearable computing device. In some embodiments, computing system 200 may be implemented in an automobile, for example in an entertainment center or console of an automobile, or is included or implemented in a healthcare device. Further, computing system 200 may also be a server or one server amongst a plurality of servers.

As shown in FIG. 2, computing system 200 includes a network interface component (NIC) 202 configured for communication with a network such as network 108 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), near field communication (NFC), and/or infrared (IR) components configured for communication with network 108. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 108.

Consistent with some embodiments, computing system 200 includes a system bus 204 for interconnecting various components within computing system 200 and communication information between the various components. Such components include a processing component 206, which may be one or more processors, micro-controllers, or digital signal processors (DSP), graphics processing units (GPUs), a system memory component 208, which may correspond to random access memory (RAM), an internal memory component 210, which may correspond to read-only memory (ROM), and an external or static memory 212, which may correspond to optical, magnetic, or solid-state memories. Consistent with some embodiments, computing system 200 further includes a display component 214 for displaying information to a user 110 of computing system 200. Display component 214 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 216, allowing for user 110 of computing system 200 to input information to computing system 200. Such information could include payment information such as an amount required to pay for a transaction, account information, authentication information, or identification information. An input component 216 may include, for example, a keyboard or key pad, whether physical or virtual. Computing system 200 may further include a navigation control component 218, configured to allow a user to navigate along display component 214. Consistent with some embodiments, navigation control component 218 may be a mouse, a trackball, or other such device. Moreover, if device 200 includes a touch screen, display component 214, input component 216, and navigation control 218 may be a single integrated component, such as a capacitive sensor-based touch screen or other touch screen.

Computing system 200 may perform specific operations by processing component 206 executing one or more sequences of instructions contained in system memory component 208, internal memory component 210, and/or external or static memory 212. In other embodiments, hard-wired circuitry may be used in place of or in combination with software instructions to implement the present disclosure. Logic may be encoded in a computer readable medium, which may refer to any medium that participates in providing instructions to processing component 206 for execution. Such a medium may take many forms, including but not limited to, non-volatile media, volatile media, and transmission media. The medium may correspond to any of system memory 208, internal memory 210 and/or external or static memory 212. Consistent with some embodiments, the computer readable medium is non-transitory. In various implementations, non-volatile media include optical or magnetic disks, volatile media includes dynamic memory, and transmission media includes coaxial cables, copper wire, and fiber optics, including wires that comprise system bus 204. According to some embodiments, transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 220 to network 108 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 220 and network interface component 202. Communication link 220 may be wireless through a wireless data protocol such as Wi-Fi™, 3G, 4G, HSDPA, LTE, RF, NFC, or through a wired connection. Network interface component 202 may include an antenna, either separate or integrated, to enable transmission and reception via communication link 220. Received program code may be executed by processing component 206 as received and/or stored in memory 208, 210, or 212.

Computing system 200 may also include sensor components 222. Sensor components 222 provide sensor functionality, and may correspond to sensors built into computing system 200 or sensor peripherals coupled to computing system 200. Sensor components 222 may include any sensory device that captures information related to user 110 and/or computing system 200, which may correspond to user device 102, that may be associated with any transactions that user 110 performs with remote server 106. This captured information may then be presented to user 110 when user 110 disputes a transaction by dispute resolution application 126. Sensor components 222 may include camera and imaging components, accelerometers, biometric readers, GPS devices, motion capture devices, and other devices that are capable of providing information about computing system 200 or user 110, or an environment therearound. Consistent with some embodiments, the information captured may include biometric information, such as fingerprints, eye scans, thumb, hand, or finger size, and interactions characteristics, such as typing styles and speeds, swipe characteristics, and the like.

Computing system 200 may include more or less components than shown in FIG. 2 according to some embodiments. Moreover, components shown in FIG. 2 may be directly coupled to one or more other components in FIG. 2, eliminating a need for system bus 204. Furthermore, components shown in FIG. 2 may be shown as being part of a unitary system 200, but may also be part of a system where the components are separate but coupled and in communication. In general, the components shown in FIG. 2 are shown as examples of components in a computing system 200 capable of performing embodiments disclosed herein. However, a processing system 200 may have more or fewer components and still be capable of performing some embodiments disclosed herein.

Consistent with some embodiments, user 110 using computing system 200 that may correspond to user device 102 may have purchased items from merchant server 104 using remote server 106, wherein remote server 106 may have been used as a gateway to merchant server 104, an intermediary, or for facilitation a payment to merchant server 104. In some embodiments, user 110 may have had a problem with the purchased items, and may want to dispute the transaction. For example, user 110 may have been provided with a defective, broken, or poor fitting version of the purchased item and wish to dispute the transaction by returning the provided item for a refund of the payment. As another example, user 110 may have accidentally purchased the wrong item and wishes to dispute the transaction to obtain a refund. As yet an additional example, user 110 may have been provided with an item that they did not purchase, and wishes to return to the merchant In these examples, user 110 has a legitimate reason for disputing a transaction that included providing items in exchange for a payment. However, some dishonest users 110 may engage in “liar-buyer” fraud wherein user 110 lies during the dispute resolution process to obtain a financial gain to the detriment of the online entity. Such behavior, as discussed previously, may include disputing a transaction and indicating that a purchased item was never received and requesting a refund when, in fact, the item was received. Accordingly, there is a need for systems and methods for reducing fraudulent activity in transaction dispute resolution.

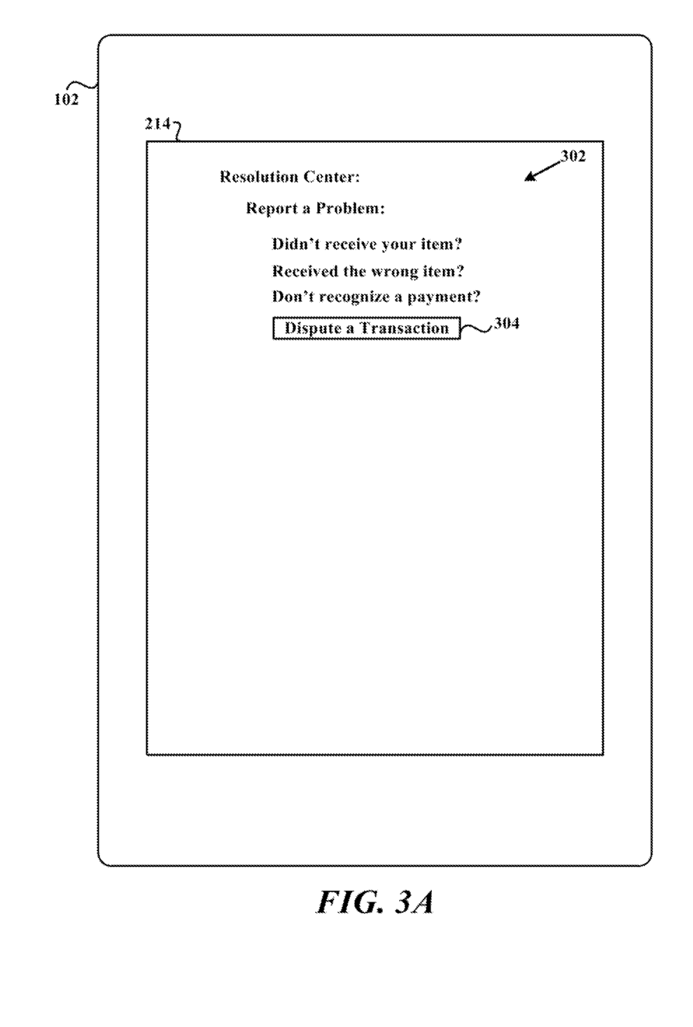

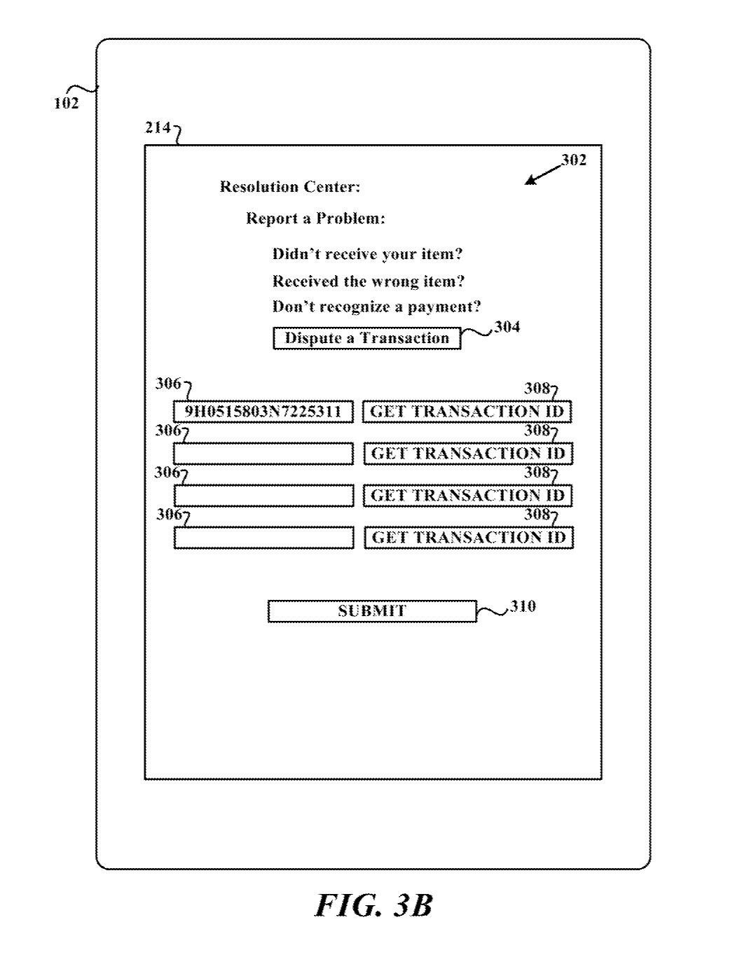

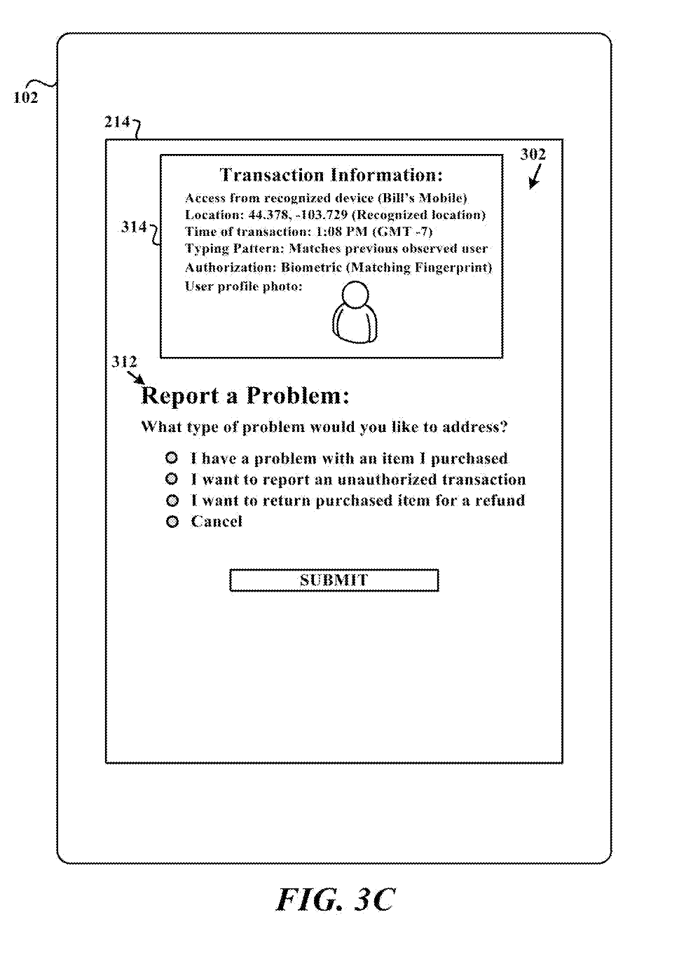

FIGS. 3A-3C are illustrations of a user interface for dispute resolution, consistent with some embodiments. User 110 using user device 102 may wish to dispute a transaction that was made with remote server 106. Consistent with some embodiments, the transaction may be a purchase of items from merchant server 104 using remote server 106 as, for example, a payment service process server. Further consistent with some embodiments, user 110 may user browser application 112 executing on user device 102 to access remote server 106 to dispute a transaction, and remote server 106 may handle the transaction dispute using dispute resolution application 126. Dispute resolution application 126 may transmit information to user device 102 for displaying on display component 214 such as shown in FIG. 3A.

As shown in FIG. 3A, user device 102 having display component 214 may display a user interface 302 that includes a selection item or button 304 for user 110 to select to initiate the dispute resolution process. Button 304 may be selected by user 110 using input control 216, navigation control 218, or a combination thereof. As shown in FIG. 3B, after selecting button 304, user may be presented with one or more form fillable fields 306 for entering a transaction identifier (ID). The transaction ID may be a number or an alphanumeric string. User interface 302 may also include a selection 308 that will allow user 110 to retrieve the transaction identifier using other means, such as by user name, date, purchase price, seller, item, etc. Once user 110 has entered the transaction ID, user 110 may select the submit button 310.

Once user 110 selects submit button 310, dispute resolution application 126 transmits user interface information for display on display component 214. As shown in FIG. 3C, user interface 302 displays a section 312 where user 110 is able to report a specific problem with the transaction. User interface 302 also displays a section that includes transaction information 314. Consistent with some embodiments, when user 110 conducts a transaction with remote server 106, remote server 106 collects information regarding user 110, user device 102, and other relevant information related to the transaction. According to some embodiments, this information is collected by information collection application 118 and transmitted to remote server 106 for storage in account information 130 in account database 128. The information that is collected may include information related to the device used to enter into the transaction, the location where the transaction was entered into, the time of the transaction, and a profile photo for user 110. The information captured may also include information captured with sensor component 222, such as biometric information, such as fingerprints, eye scans, thumb, hand, or finger size, and interactions characteristics, such as typing styles and speeds, swipe characteristics, and the like. The information may also include a street level view of the location where the transaction was performed or an address on file for user 110 as provided by a mapping service such as Google® Street View. The information may also include a photograph of the item purchased during the transaction, such as a photo of the delivered item. Other automatic shipping updates regarding the purchased item may also be presented as part of information 314. Further, should user perform a high-quality authentication when accessing remote server 106, the high-quality authentication method used may be captured.

Returning to FIG. 3C, when user 110 is initiating the transaction dispute, dispute resolution application 126 may retrieve captured information associated with the transaction from account information 130 in account database 128, and transmit this information to user device 102 for display on display component 214 in user interface 302. Consistent with some embodiments, remote server 106 may prepare the retrieved information for rendering prior to transmitting the information. Alternatively, the information may be transmitted to user device 102 to be prepared for rendering and rendered by user device 102. User 110 will be able to review this information before continuing to report a problem. Consistent with some embodiments, remote server 106 and dispute resolution application 126 may monitor how often user 110 uses dispute resolution and is shown information 314. Since this information is sensitive, repeated uses of the dispute resolution to view this information may be indicative of an attacker attempting to gain access to the information, and remote server 106 will no longer allow user 110 access to information 314 if there are repeated uses.

In some embodiments, information 314 may be specific enough to deter fraudulent dispute resolution behavior. For example, a fraudulent user 110 may see information 314 and be careful about fraudulently disputing a transaction believing that the merchant or the payment service provider has enough information about them that they may be caught, and cancel the dispute resolution. As a result, fraudulent user 110 may be less likely to conduct a fraudulent dispute resolution.

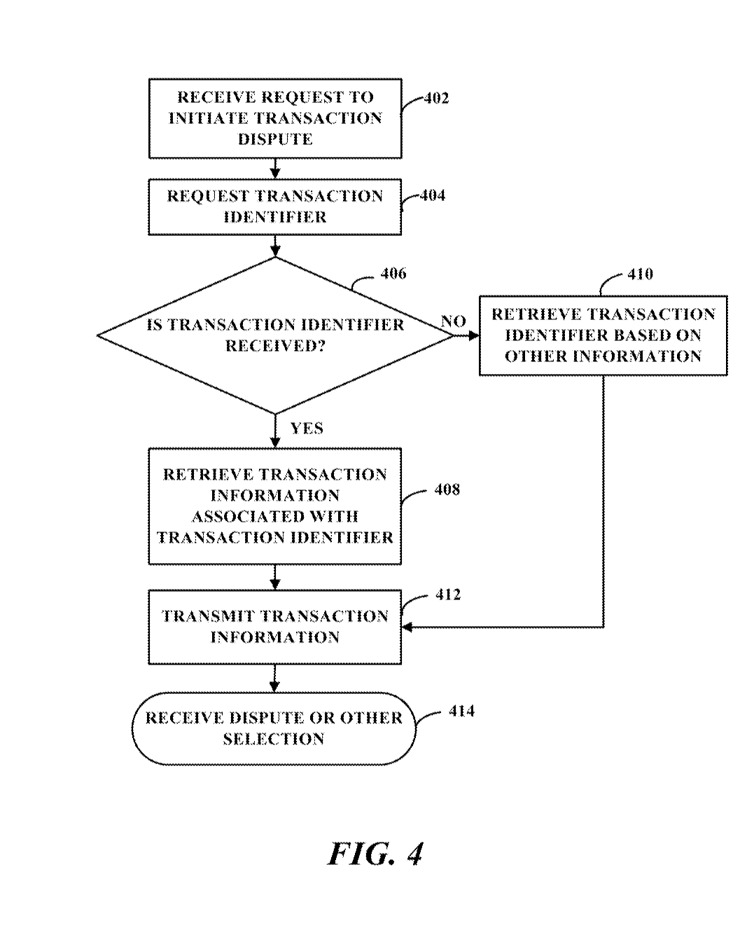

FIG. 4 is a flowchart illustrating a method for resolving transaction disputes, consistent with some embodiments. For the purpose of illustration, FIG. 4 will be described with reference to FIGS. 1-2, and 3A-3C. The method shown in FIG. 4 may be embodied in computer-readable instructions for execution by one or more processors in processing component 206 such that the steps of the method may be performed by remote server 106. As shown in FIG. 4, remote server 106 may receive a request to initiate a transaction dispute (402). Consistent with some embodiments, the request may be received from user device 102 when user 110 selects or clicks button 304 displayed on user interface 302 by instructions transmitted to user device 102 over network 108 by dispute resolution application 126 in remote server 106. Further consistent with some embodiments, the transaction that is being disputed may be a transaction made with merchant server 104 that was facilitated by remote server 106. Remote server 106 may then request a transaction identifier (404). Consistent with some embodiments, transaction identifier (ID) may be a number or an alphanumeric string that was assigned by remote server 106 to the transaction. If user 110 using user device 102 enters and transmits a transaction ID to remote server 106 (406), dispute resolution application 126 of remote server 106 may retrieve transaction information associated with the received transaction ID (408). Consistent with some embodiments, the retrieved transaction information may include relevant information about the transaction that is captured by information collection application 118 and transmitted to remote server 106 and stored in account information 130 in account database 128 when the transaction is made.

If remote server 106 does not receive the transaction ID, remote server 106 will retrieve the relevant transaction information based on other information (410). Consistent with some embodiments, the other information may include a user name, date, purchase price, seller, or item. Once the transaction information has been retrieved, it will be transmitted (412). The transaction information may be transmitted to user device 102 over network 108 for display in user interface 302. In some embodiments, remote server 106 may prepare the retrieved information for rendering prior to transmitting the retrieved information. Alternatively, remote server 106 may transmit the retrieved information to user device 102 which will prepare the information for rendering and then render the information. Once user 110 has reviewed the displayed transaction information, user 110 may dispute the transaction or select another selection that is not a dispute. Examples of selections that are not disputes include canceling the dispute process, or requesting to return the item for a full or partial refund. Consistent with some embodiments, users who are attempting to engage in fraudulent activities may review the transaction information and, if they see information that is relevant to the transaction and shows that they likely engaged in the transaction, may be more likely to cancel the dispute process, out of fear of getting caught. Users who have a legitimate dispute, on the other hand, will continue to dispute the transaction and enter the actual dispute. Remote server 106 will then receive the dispute or other selection (414) where it will be handled according to predefined protocol set by administrators of remote server 106.

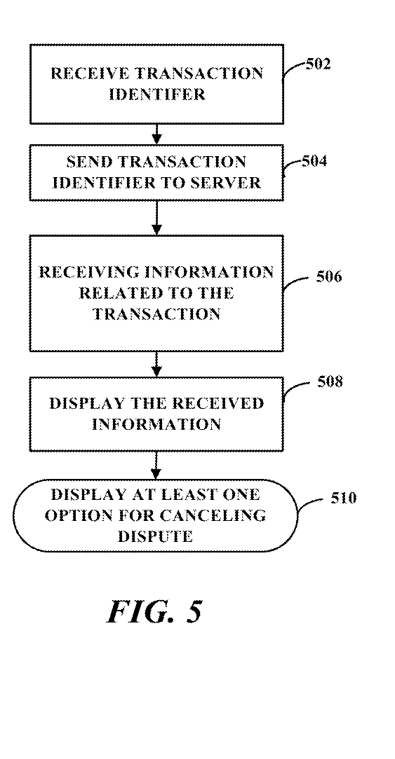

FIG. 5 is a flowchart illustrating a method for deterring fraudulent behavior when disputing transactions, consistent with some embodiments. For the purpose of illustration, FIG. 5 will be described with reference to FIGS. 1-2, and 3A-3C. The method shown in FIG. 5 may be embodied in computer-readable instructions for execution by one or more processors in processing component 206 such that the steps of the method may be performed by user device 102. As shown in FIG. 5, user device 102 may receive a transaction identifier to initiate a transaction dispute (502). Consistent with some embodiments, user 110 may enter transaction identifier using input component 216 for reception by user device 102. Consistent with some embodiments, the transaction identifier may be a number or an alphanumeric string that was assigned by remote server 106 to the transaction, a user name, date, purchase price, seller, or item. User device 102 may then send the received transaction identifier to remote server 106 over network 108 (504). User device 102 may then receive information related to the transaction (506) and display the received information on display component 214 of user device 102 (508). In some embodiments, the received information related to the transaction may include relevant information about the transaction that is captured by information collection application 118 and transmitted to remote server 106 and stored in account information 130 in account database 128 when the transaction is made. Such information may include information related to a device, such as user device 102, used to enter into the transaction, a location where the transaction was entered into, a time of the transaction, a profile photo for user 110, as biometric information of user 110, and user 110 interaction characteristics. Display component 214 of user device 102 may then display at least one option for canceling the transaction dispute (510). Consistent with some embodiments, users who are attempting to engage in fraudulent behavior related to the transaction dispute may review the transaction information and, if they see information that is relevant to the transaction and shows that they likely engaged in the transaction, may be more likely to cancel the dispute process, out of fear of getting caught, thus deterring fraudulent behavior. Users who have a legitimate dispute, on the other hand, may continue to dispute the transaction and enter the actual dispute.

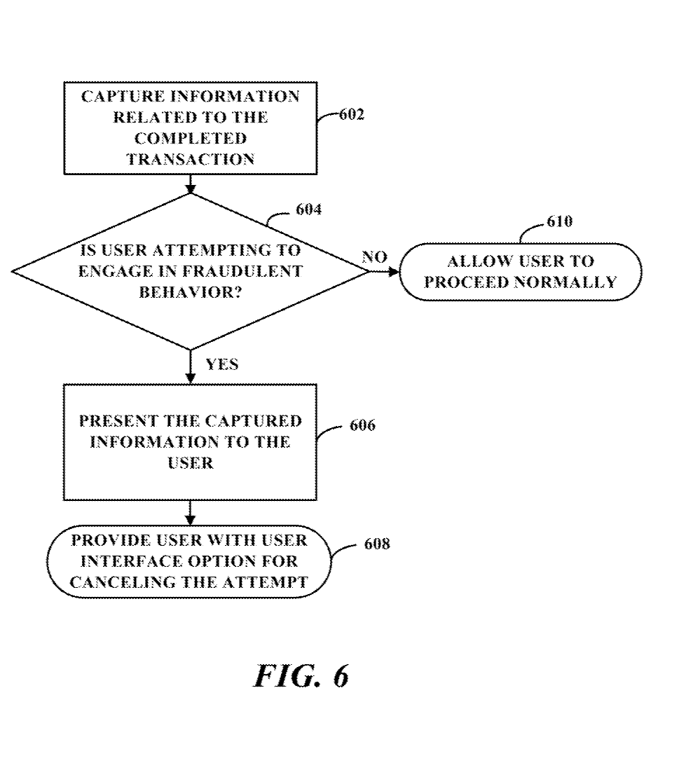

FIG. 6 is a flowchart illustrating a method for deterring fraudulent behavior related to a transaction, consistent with some embodiments. For the purpose of illustration, FIG. 6 will be described with reference to FIGS. 1-2, and 3A-3C. The method shown in FIG. 6 may be embodied in computer-readable instructions for execution by one or more processors in processing component 206 such that the steps of the method may be performed by user device 102. As shown in FIG. 6, user device 102 may capture information related to the transaction (602). In some embodiments, information collection application 118 may collect information when the transaction is entered into or during the transaction and may send the collected information to remote server 106 for storage in account information 130 in account database 128. Such information may include information related to a device, such as user device 102, used to enter into the transaction, a location where the transaction was entered into, a time of the transaction, a profile photo for user 110, as biometric information of user 110, and user 110 interaction characteristics. If user 110 is attempting to engage in fraudulent behavior regarding the transaction (604), remote server 106 may transmit the captured information to user device 102, which may then present the captured information to user 110 (606). In some embodiments, user device 102 may present the captured information by displaying the information on display component 214. Display component 214 of user device 102 may then display a user interface option for canceling the attempt to engage in fraudulent behavior (608). If user 110 is not attempting engage in fraudulent behavior, for example user 110 is legitimately attempting to dispute the transaction, user 110 may be allowed to proceed with a transaction dispute normally (610). Consistent with some embodiments, users who are attempting to engage in fraudulent behavior related to the transaction may review the captured information and, if they see information that is relevant to the transaction and shows that they likely engaged in the transaction, may be more likely to cancel the fraudulent attempt, out of fear of getting caught, thus deterring fraudulent behavior.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may provide systems and methods for reducing fraudulent activity in transaction dispute resolution, while not affecting a legitimately aggrieved user from resolving a disputed transaction. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A system for resolving a transaction dispute, comprising:
a memory storing transaction information;
one or more processors coupled to the memory, the one or more processors configured to retrieve the transaction information based on a received transaction identifier from a user; and
a network interface component coupled to the memory and the one or more processors, the network interface component configured to:
transmit the retrieved transaction information and instructions providing the user with an opportunity to select an option that is not a transaction dispute.

2. The system of claim 1, wherein the transaction information comprises at least one of information related to a device used to enter into the transaction, a location where the transaction was entered into, a time of the transaction, a profile photo for the user, biometric information of the user, and user interaction characteristics.

3. The system of claim 1, wherein the transaction identifier comprises an alphanumeric string.

4. The system of claim 1, wherein the transaction identifier comprises at least one of a buyer identification, a seller identification, a transaction date, a purchase price, and an item purchased in the transaction.

5. A method for resolving a transaction dispute, comprising:
receiving, by a server coupled to a network, an initiation of a transaction dispute;
retrieving, by the server, information related to the transaction;
preparing, by the server, the retrieved information for rendering;
transmitting, from the server, the prepared information to a user device for rendering the retrieved information to a user before the user disputes the transaction; and
providing, by the server, the user with an opportunity to select an option that is not a transaction dispute.

6. The method of claim 5, wherein the retrieving information related to the transaction comprises retrieving at least one of information related to a device used to enter into the transaction, a location where the transaction was entered into, a time of the transaction, a profile photo for the user, biometric information of the user, and user interaction characteristics.

7. The method of claim 5, wherein retrieving information related to the transaction comprises retrieving information using a transaction identifier.

8. The method of claim 7, wherein the transaction identifier comprises an alphanumeric string.

9. The method of claim 5, wherein retrieving information related to the transaction comprises retrieving information by at least one of a buyer identification, a seller identification, a transaction date, a purchase price, and an item purchased in the transaction.

10. A method for deterring fraudulent behavior when disputing a transaction, comprising:
receiving, by a client device, an identifier associated with the transaction;
sending, by the client device, the received identifier to a server associated with the transaction;
receiving, by the client device, information related to the transaction;
displaying, by the client device, the information related to the transaction to a user of the client device; and
displaying, by the client device, at least one option to the user to cancel the transaction dispute.

11. The method of claim 10, wherein receiving information related to the transaction comprises receiving at least one of information related to a device used to enter into the transaction, a location where the transaction was entered into, a time of the transaction, a profile photo for the user, biometric information of the user, and user interaction characteristics.

12. The method of claim 10, wherein receiving an identifier associated with the disputed transaction comprises receiving at least one of a transaction identifier, a buyer identification, a seller identification, a transaction date, a purchase price, and an item purchased in the transaction.

13. A method for deterring fraudulent behavior related to a transaction, comprising:
capturing, by a client device, information related to the transaction, the captured information including details of the transaction;
presenting, by a display device of the client device, the captured information to the user when the user attempts to engage in fraudulent behavior related to the transaction;
providing, by the client device, the user with a user interface option for canceling the attempt to engage in fraudulent behavior related to the transaction.

14. The method of claim 13, wherein capturing information related to the transaction comprises capturing at least one of information related to a device used to enter into the transaction, a location where the transaction was entered into, a time of the transaction, a profile photo for the user, biometric information of the user, and user interaction characteristics.

15. The method of claim 13, wherein presenting the captured information to the user when the user attempts to engage in fraudulent behavior related to the transaction comprises presenting the captured information to the user when the user attempts to fraudulently dispute the transaction.

16. The method of claim 13, wherein presenting the captured information to the user when the user attempts to engage in fraudulent behavior related to the transaction comprises receiving the captured information from a server over a network.

17. The method of claim 15, wherein providing the user with a user interface option for canceling the attempt to engage in fraudulent behavior related to the transaction comprises providing the user with a user interface option for canceling the fraudulent dispute of the transaction.

18. The method of claim 17, wherein providing the user with a user interface option for canceling the fraudulent dispute of the transaction comprises presenting the user interface option on the display device of the client device.

19. The method of claim 17, wherein when a user selects the user interface option for canceling the fraudulent dispute of the transaction, the method further comprises transmitting the user selection of the cancellation to a server.

20. The method of claim 13, further comprising:
receiving, by the client device, an identifier associated with the transaction;
sending, by the client device, the received identifier to a server associated with the transaction; and
receiving, by the client device, the captured information.
